(19) United States
(12) Patent Application Publication
(10) Pub. No.: US 2026/0156664 A1
(43) Pub. Date: Jun. 4, 2026

(54) FRONTHAUL LOAD ENHANCEMENT FOR PERIODIC INFORMATION IN RADIO ACCESS NETWORKS

(71) Applicant: QUALCOMM Incorporated, San Diego, CA (US)

(72) Inventors: Venkata Srikanth POLURU, Hyderabad (IN); Subrahmanyam VUDDAGIRI, Hyderabad (IN); Raghu Babu MOVVA, Hyderabad (IN)

(21) Appl. No.: 18/967,487

(22) Filed: Dec. 3, 2024

(51) Int. Cl. H04W 72/52

(52) U.S. Cl. CPC H04W 72/52

(57) ABSTRACT

Methods, systems, and devices for wireless communications are described. Generally, the described techniques enable a radio unit (RU) to receive a control-plane packet that indicates control information, the control information indicating periodic resources. The RU may communicate, via the periodic resources, two or more periodic messages based on the control information. That is, rather than receive multiple control-plane packets for each periodic message, the RU communicates multiple periodic messages using the control information. In some examples, the RU may receive the control information and a periodicity of the periodic resources via a section type in the control-plane packet. In some other examples, the RU may receive the control information and the periodicity via a section extension of the control-plane packet.

### FIELD OF TECHNOLOGY

The following relates to wireless communications, including fronthaul load enhancement for periodic information in radio access networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a distributed unit of a network entity may transmit one or more control-plane packets to a radio unit of the network entity to indicate time-frequency resource allocations for communications with one or more UEs.

### SUMMARY

The systems, methods, and devices of this disclosure each have several innovative aspects, no single one of which is solely responsible for the desirable attributes disclosed herein.

A method for wireless communications by a radio unit (RU) node is described. The method may include receiving, via a control plane established between the RU node and a distributed unit node over a fronthaul interface, a control-plane packet that indicates control information, the control information indicating periodic resources in a set of multiple transmission time intervals (TTIs) allocated for communication of traffic associated with the RU node, communicating, via a first resource of the periodic resources, a first message based on the control information, and communicating, via a second resource of the periodic resources, a second message based on the control information, the second resource and the first resource occurring in different TTIs of the set of multiple TTIs.

An RU node for wireless communications is described. The RU node may include one or more memories storing processor executable code, and one or more processors coupled with the one or more memories. The one or more processors may individually or collectively be operable to execute the code to cause the RU node to receive, via a control plane established between the RU node and a distributed unit node over a fronthaul interface, a control-plane packet that indicates control information, the control information indicating periodic resources in a set of multiple TTIs allocated for communication of traffic associated with the RU node, communicate, via a first resource of the periodic resources, a first message based on the control information, and communicate, via a second resource of the periodic resources, a second message based on the control information, the second resource and the first resource occurring in different TTIs of the set of multiple TTIs.

Another RU node for wireless communications is described. The RU node may include means for receiving, via a control plane established between the RU node and a distributed unit node over a fronthaul interface, a control-plane packet that indicates control information, the control information indicating periodic resources in a set of multiple TTIs allocated for communication of traffic associated with the RU node, means for communicating, via a first resource of the periodic resources, a first message based on the control information, and means for communicating, via a second resource of the periodic resources, a second message based on the control information, the second resource and the first resource occurring in different TTIs of the set of multiple TTIs.

A non-transitory computer-readable medium storing code for wireless communications is described. The code may include instructions executable by one or more processors to receive, via a control plane established between an RU node and a distributed unit node over a fronthaul interface, a control-plane packet that indicates control information, the control information indicating periodic resources in a set of multiple TTIs allocated for communication of traffic associated with the RU node, communicate, via a first resource of the periodic resources, a first message based on the control information, and communicate, via a second resource of the periodic resources, a second message based on the control information, the second resource and the first resource occurring in different TTIs of the set of multiple TTIs.

Some examples of the method, RU nodes, and non-transitory computer-readable medium described herein may further include operations, features, means, or instructions for receiving, in the control-plane packet, a starting indication associated with the periodic resources, where the first message and the second message may be communicated based on the starting indication. Some examples of the method, RU nodes, and non-transitory computer-readable medium described herein may further include operations, features, means, or instructions for receiving, in the control-plane packet, a stop indication associated with the periodic resources.

Some examples of the method, RU nodes, and non-transitory computer-readable medium described herein may further include operations, features, means, or instructions for receiving an indication of a quantity of TTIs between receipt of the control-plane packet and when the control-plane packet may be applied, where the first message and the second message may be communicated after the quantity of TTIs may have elapsed.

In some examples of the method, RU nodes, and non-transitory computer-readable medium described herein, the control-plane packet includes an allocation identifier and a control section field that includes first control data, the control-plane packet indicating to apply the first control data in one or more TTIs of the set of multiple TTIs until a subsequent control-plane packet may be received that includes the allocation identifier.

In some examples of the method, RU nodes, and non-transitory computer-readable medium described herein, the control-plane packet may indicate a starting system frame number associated with the periodic resources, a starting TTI associated with the periodic resources, a layer identifier associated with the periodic resources, a quantity of TTIs associated with the periodic resources, or any combination thereof. In some examples of the method, RU nodes, and non-transitory computer-readable medium described herein, the control-plane packet may include operations, features, means, or instructions for an extension field, an extension flag, a section extension type, an extension length, an allocation identifier, a starting flag associated with the periodic resources, a stopping flag associated with the periodic resources, a periodicity associated with the periodic resources, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports fronthaul load enhancement for periodic information in radio access networks (RANs) in accordance with one or more aspects of the present disclosure.

FIG. 2 shows an example of a network architecture that supports fronthaul load enhancement for periodic information in RANs in accordance with one or more aspects of the present disclosure.

FIG. 3 shows an example of a wireless communications system that supports fronthaul load enhancement for periodic information in RANs in accordance with one or more aspects of the present disclosure.

FIG. 4 shows an example of a process flow that supports fronthaul load enhancement for periodic information in RANs in accordance with one or more aspects of the present disclosure.

FIGS. 5 and 6 show block diagrams of devices that support fronthaul load enhancement for periodic information in RANs in accordance with one or more aspects of the present disclosure.

FIG. 7 shows a block diagram of a communications manager that supports fronthaul load enhancement for periodic information in RANs in accordance with one or more aspects of the present disclosure.

FIG. 8 shows a diagram of a system including a device that supports fronthaul load enhancement for periodic information in RANs in accordance with one or more aspects of the present disclosure.

FIGS. 9 and 10 show flowcharts illustrating methods that support fronthaul load enhancement for periodic information in radio access networks in accordance with one or more aspects of the present disclosure.

### DETAILED DESCRIPTION

In some wireless communications systems, a network entity may communicate periodic messages with one or more user equipment (UEs) via periodic resource allocations. For example, the network entity may communicate channel state information (CSI) reports with the one or more UEs via periodic physical uplink control channel (PUCCH) allocations, among other examples. In some examples, the network entity may be implemented in a disaggregated architecture, such as a radio access network (RAN), and the network entity may include one or more of a central unit (CU), a distributed unit (DU), a radio unit (RU), or any combination thereof. In such examples, a DU may transmit control-plane packets that indicate the periodic resource allocation information to an RU via a fronthaul interface, and the RU may communicate messages with the one or more UEs based on receiving the control-plane packets. However, in other wireless communications systems, the DU may transmit a control-plane packet for each transmission time interval (TTI) in which the messages occur. Transmitting a control-plane packet indicating the periodic resource allocation information for each TTI for one or more messages may increase an overhead in the throughput of the fronthaul interface as well as an amount of processing at the RU (e.g., the RU may process each control-plane packet received).

In some implementations of the present disclosure, an RU may receive a control-plane packet over the fronthaul interface that indicates control information associated with a resource allocation and a periodicity corresponding to the resource allocation. The RU may communicate, via the periodic resources, two or more messages based on the resource allocation and the periodicity. That is, rather than receive multiple control-plane packets for each message, the techniques described herein enable the RU to communicate multiple messages using the control information. Receiving an indication of the control information and periodicity at the RU and communicating multiple messages in accordance with the periodicity may reduce a throughput overhead of the fronthaul interface and a processing overhead at the RU (e.g., the RU may process fewer packets compared to other wireless communications systems that transmit packets for each message).

In some examples, the RU may receive the control information and the periodicity via a section type in the control-plane packet. For example, the section type may indicate a layer identifier of the resource allocation, a periodicity of the allocation (e.g., in quantity of TTIs), and the RU may apply the section type for the given layer identifier starting from a TTI (e.g., system frame number, subframe, or slot) indicated in a header of the control-plane packet. In some other examples, the RU may receive the control information and the periodicity via a section extension of the control-plane packet. For example, the control-plane packet may include an extension field that indicates the section extension, and the section extension may include the resource allocation identifier and the periodicity.

Aspects of the disclosure are initially described in the context of wireless communications systems and a network architecture. Aspects of the disclosure are then illustrated by and described with reference to a wireless communications system and a process flow. Aspects of the disclosure are further illustrated by and described with reference to apparatus diagrams, system diagrams, and flowcharts that relate to fronthaul load enhancement for periodic information in RANs.

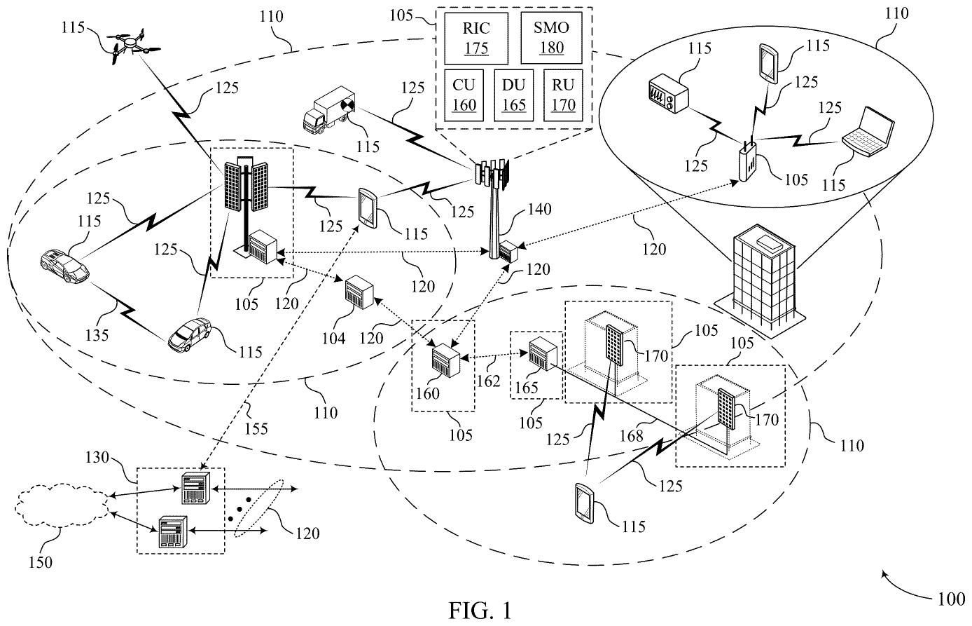

FIG. 1 shows an example of a wireless communications system 100 that supports fronthaul load enhancement for periodic information in RANs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support fronthaul load enhancement for periodic information in RANs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems, a network entity 105 may communicate periodic messages with one or more UEs 115 via periodic resource allocations. For example, the network entity 105 may communicate CSI reports with the one or more UEs 115 via PUCCH allocations, among other examples. In some examples, the network entity 105 may be implemented in a disaggregated architecture, such as an O-RAN, and the network entity 105 may include one or more of a CU 160, a DU 165, an RU 170, or any combination thereof. In such examples, a DU 165 may transmit control-plane packets that indicate the periodic resource allocation information to an RU 170 via a fronthaul interface, and the RU 170 may communicate the periodic messages with the one or more UEs 115 based on receiving the control-plane packets. However, in other wireless communications systems, the DU 165 may transmit a control-plane packet for each TTI in which the periodic messages occur. Transmitting a control-plane packet indicating the resource allocation information for each TTI for one or more periodic messages may increase an overhead in the throughput of the fronthaul interface as well as an amount of processing at the RU 170 (e.g., the RU 170 may process each control-plane packet received).

In some implementations of the present disclosure, an RU 170 may receive a control-plane packet over the fronthaul interface that indicates control information associated with a resource allocation and a periodicity corresponding to the resource allocation. The RU 170 may communicate, via the periodic resources, two or more periodic messages based on the resource allocation and the periodicity. That is, rather than receive multiple control-plane packets for each periodic message, the techniques described herein enable the RU 170 to communicate multiple periodic messages using the control information. Receiving an indication of the control information and periodicity at the RU 170 and communicating multiple messages in accordance with the periodicity may reduce a throughput overhead of the fronthaul interface and a processing overhead at the RU 170 (e.g., the RU 170 may process fewer packets compared to other wireless communications systems that transmit packets for each message).

In some examples, the RU 170 may receive the control information and the periodicity via a section type in the control-plane packet. For example, the section type may indicate a layer identifier of the resource allocation, a periodicity of the allocation (e.g., in quantity of TTIs), and the RU 170 may apply the section type for the given layer identifier starting from a TTI (e.g., system frame number, subframe, or slot) indicated in a header of the control-plane packet. In some other examples, the RU 170 may receive the control information and the periodicity via a section extension of the control-plane packet. For example, the control-plane packet may include an extension field that indicates the section extension, and the section extension may include the resource allocation identifier and the periodicity.

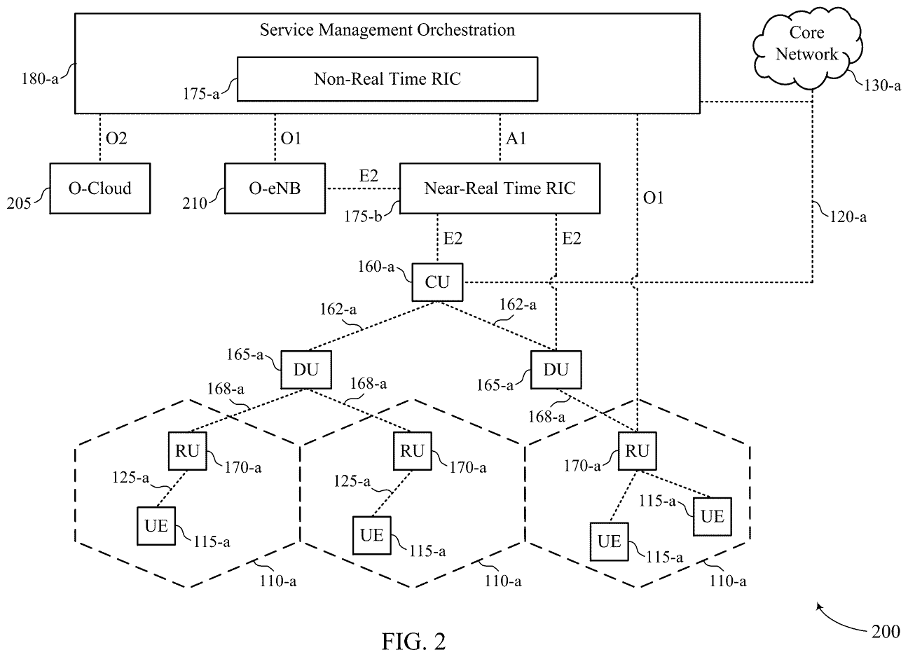

FIG. 2 shows an example of a network architecture 200 (e.g., a disaggregated base station architecture, a disaggregated RAN architecture) that supports fronthaul load enhancement for periodic information in RANs in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

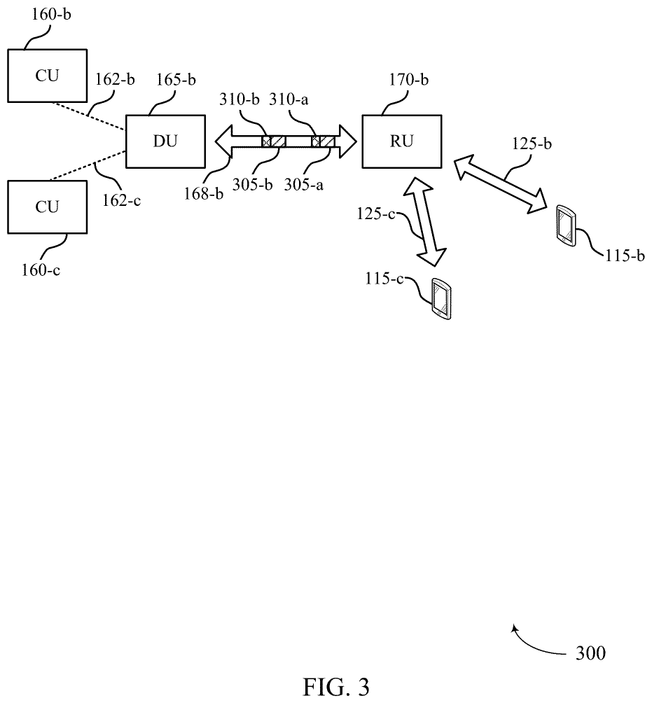

FIG. 3 shows an example of a wireless communications system 300 that supports fronthaul load enhancement for periodic information in RANs in accordance with one or more aspects of the present disclosure. The wireless communications system 300 may implement or be implemented by aspects of the wireless communications system 100 or the network architecture 200, as described with reference to FIGS. 1 and 2. For example, the wireless communications system 300 includes a first CU 160-b, a second CU 160-c, a DU 165-b, an RU 170-b, a first UE 115-b, and a second UE 115-c, which may be examples of corresponding devices described herein, including with reference to FIGS. 1 and 2.

The first CU 160-b and the second CU 160-c may communicate with the DU 165-b over a first midhaul communication link 162-b and a second midhaul communication link 162-c, respectively. In some examples, the first CU 160-b may be a control-plane CU (e.g., a CU-CP), and the second CU 160-c may be a user-plane CU (e.g., a CU-UP). The DU 165-b may communicate with the RU 170-b over a fronthaul communication link 168-b.

In some examples, the fronthaul communication link 168-b may include a control-plane interface and a user-plane interface. For example, the RU 170-b may receive time-frequency resource allocations, such as physical resource block (PRB) allocations, for communications with one or more UEs 115. The DU 165-b may indicate (e.g., based on communicating with the first CU 160-b) the resource allocations to the RU 170-b via one or more control-plane packets 305 over the control-plane interface in the fronthaul communication link 168-b. Additionally, or alternatively, the DU 165-b may indicate (e.g., based on communicating with the second CU 160-c) data for the resource allocations to the RU 170-b over the user-plane interface in the fronthaul communication link 168-b. Using the resource allocations indicated via the one or more control-plane packets 305, the RU 170-b may communicate the data with the first UE 115-b or the second UE 115-c over a first communication link 125-b or a second communication link 125-c, respectively.

In some wireless communications systems, such as an O-RAN communications system, there may be multiple types of periodic resource allocations for communications. For example, the RU 170-b may communicate with the first UE 115-b and the second UE 115-c using periodic physical uplink shared channel (PUSCH) PRB allocations or physical downlink shared channel (PDSCH) PRB allocations via semi-persistent scheduling (SPS), such as in Voice over LTE (VoLTE) or Voice over NR (VONR). Additionally, or alternatively, the first UE 115-b, the second UE 115-c, or both, may use periodic physical uplink control channel (PUCCH) allocations for synchronization signal block resource indications (SSB-RI), CSI reports, and the like. In another example, the RU 170-b and the UEs 115 may communicate CSI reference signals (CSI-RS), synchronization signal block (SSB) beams, sounding reference signals (SRS), or any combination thereof, using periodic resource allocations. As described herein, a periodic resource allocation may refer to any periodic allocation of time-frequency resources to be used for transmissions between the RU 170-b and one or more UEs 115 or between the RU 170-b and another network entity (such as the DU 165-b). Data within a respective transmission sent via a respective periodic resource allocation may change while the allocation of the time-frequency resources may be re-used in accordance with a corresponding periodicity.

In some other wireless communications systems, a DU 165 may transmit, for each TTI in which periodic communications occur, a control-plane packet to an RU 170 that indicates the periodic resource allocation for the periodic communications. That is, the RU 170 may receive multiple control-plane packets 305 that indicate the same periodic resource allocation. Accordingly, in such other wireless communications systems, transmitting a control-plane packet for each TTI (e.g., each slot) that the periodic message occurs in may result in an overhead in fronthaul throughput and processing at the RU 170 (e.g., the RU 170 may decode each control-plane packet before applying the periodic resource allocation).

The techniques described herein enable the RU 170-b to receive, over the fronthaul communication link 168-b, a control-plane packet 305 that indicates control information, which may enable the RU 170-b to communicate with one or more UEs 115 or execute one or more commands at the RU 170-b, without receiving additional control-plane packets that indicate the same periodic resource allocation for each TTI (e.g., each slot) that the communications occur. That is, the RU 170-b may store periodic resource allocation information received over the control plane interface (e.g., PRBs, beam information) and communicate with the first UE 115-b or the second UE 115-c in accordance with the stored information. Additionally, or alternatively, the control information may include periodic commands (e.g., energy-saving commands) for the RU 170-b, and the RU 170-b may execute the commands in accordance with the stored information. Accordingly, the RU 170-b may communicate periodic messages with the one or more UEs 115 or execute commands without receiving additional control-plane packets 305 indicating the resource allocation for each TTI, which may reduce a signaling load over the fronthaul communication link 168-b and reduce a hardware load on the RU 170-b and DU 165-b for processing the additional control-plane packets 305. As described herein, it is understood that the control information may refer to an indication of a resource allocation and a periodicity corresponding to the resource allocation, one or more commands for the RU 170-b, beam information, or any combination thereof.

In some examples, the control-plane packet 305 may include a section type that indicates, e.g., in control information, that the resource allocation is periodic. For example, the RU 170-b may receive a first control-plane packet 305-a that indicates the periodicity of the allocation, a starting frame and slot number, and an identifier (e.g., an eAxc identifier (ID)) for which the current section allocation information is repeated. In some cases, the starting frame and slot number may be included in one or more fields (e.g., Frame ID, Subframe ID, Slot ID, Start Symbol ID) of the control-plane packet 305, such as within a section type slot-level configuration of the control-plane packet 305. Each field may correspond to a different quantity of bytes in the control-plane packet 305. For example, a header (e.g., transport header) of the control-plane packet 305 may span 8 bytes in a first field, and the frame ID may span 1 byte in a second field. The one or more fields included in the control-plane packet 305 are illustrated in Table 1. In some examples, the RU 170-b may apply a section type command for a given layer identifier starting from the SFN, subframe, slot, or any combination thereof, indicated in the header of the control-plane packet 305.

TABLE 1
Section Type TTI-Level Config

| | | | | | | | | | |
|---|---|---|---|---|---|---|---|---|---|
| 0 | | | | | | | | # of | Octet |
| (msb) | 1 | 2 | 3 | 4 | 5 | 6 | 7 | Bytes | # |

| Transport Header | | 8 | 1 |
|---|---|---|---|
| Frame ID | | 1 | 9 |
| Subframe ID | Slot ID | 1 | 10 |

| | | | |
|---|---|---|---|
| Slot ID | Start Symbol ID | 1 | 11 |

| | | |
|---|---|---|
| Section Type | 1 | 12 |
| Number of Section Type Commands | 1 | 13 |

TABLE 2

| Section Type | # of | Octet |
|---|---|---|
| Command | Bytes | # |
| eAxc ID | 2 | 14 |
| Periodicity | 2 | 16 |

Each section type command may indicate a layer identifier of the periodic resource allocation (e.g., eAxc ID) and a periodicity corresponding to the identifier in a quantity of TTIs (e.g., slots). The content of the section type command is illustrated in Table 2. The layer identifier may correspond to the frame ID, subframe ID, slot ID, start Symbol ID, or any combination thereof included in the first control-plane packet 305-a. For example, the starting frame and slot number in the first control-plane packet 305-a may indicate the periodic resources that correspond to the periodic resource allocation. In some examples, the control-plane packet 305 may also include one or more fields indicating a quantity of section type commands. For example, the control-plane packet 305 may indicate a quantity of resource allocation identifiers (e.g., a list of eAxc ID) to apply a periodicity.

In some examples, the first control-plane packet 305-a may include a first extension 310-a. The first extension 310-a may indicate the RU 170-b to start or stop applying the section type command. Additionally, or alternatively, the first extension 310-a may indicate a quantity of TTIs (e.g., slots) until the section type command is applicable (e.g., a duration until the RU 170-b may apply the section type command).

In some other examples, the section extension 310 included in the control-plane packet 305 may indicate, e.g., in control information, the periodicity of the resource allocation. For example, the DU 165-b may add the first extension 310-a to the first control-plane packet 305-a for periodically occurring sections to indicate the periodicity of the section. In some examples, the section may be repeated until it is stopped or overwritten with another section that includes the same allocation identifier in the control-plane packet 305 (e.g., in the payload). That is, the RU 170-b may apply the resource allocation indicated in a last received section (e.g., in the first control-plane packet 305-a) until receiving a stop indication or another control-plane packet 305 that includes a new section with the same resource allocation. For example, the RU 170-b may receive a second control-plane packet 305-b with a second extension 310-b that includes the same resource allocation but a different section type. The DU 165-b may apply the section extension 310 to any section type of the control-plane packet 305 to indicate that the resource allocation in the control-plane packet 305 is periodic.

In some examples, the section extension 310 may include one or more fields that indicate an extension flag, a section extension type, an extension length (e.g., in bits), an allocation ID, a start or stop flag, and the periodicity corresponding to the resource allocation. The extension length may indicate the length of the fields corresponding to the allocation ID, start or stop flag, and the periodicity. The RU 170-b may store (e.g., in one or more memories of the RU 170-b) the current allocation of the corresponding section type with the section extension 310 and re-use it as applicable (e.g., to communicate with the one or more UEs 115).

Based on receiving the indication of the resource allocation and the corresponding periodicity, the RU 170-b may communicate one or more messages (e.g., uplink, downlink, or both) with the one or more UEs 115. For example, the RU 170-b may communicate one or more first messages with the first UE 115-b via the first communication link 125-b in accordance with the periodicity and the resource allocation. The RU 170-b may also communicate one or more second messages with the second UE 115-c via the second communication link 125-c in accordance with the periodicity and the resource allocation. That is, based on an expiration of the periodicity, the RU 170-b may transmit, or receive, one or more messages using time-frequency resources indicated in the layer identifier (e.g., the eAxc ID included in the first control-plane packet 305-a and/or allocation ID included in the first extension 310-a).

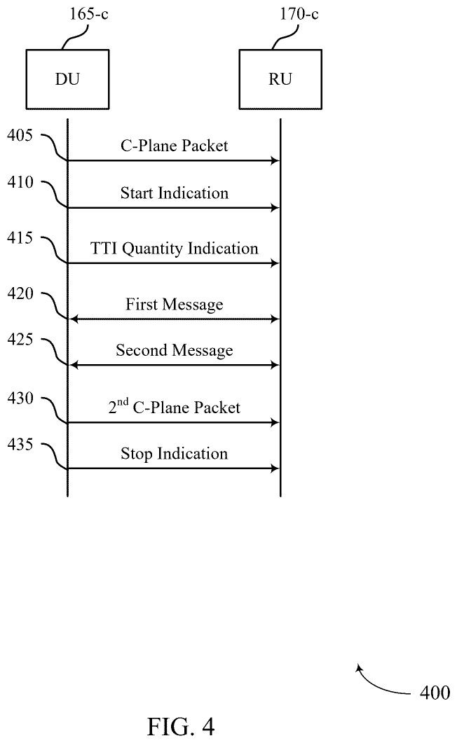

FIG. 4 shows an example of a process flow 400 that supports fronthaul load enhancement for periodic information in RANs in accordance with one or more aspects of the present disclosure. The process flow 400 may implement or be implemented by aspects of any of the wireless communications systems or network architecture described with reference to FIGS. 1 through 3. For example, the process flow 400 includes a DU 165-c and an RU 170-c, which may be examples of corresponding devices described herein, including with reference to FIGS. 1 through 3. In the following description of the process flow 400, operations between the DU 165-c and the RU 170-c may be added, omitted, or performed in a different order (with respect to the exemplary order shown).

At 405, the RU 170-c may receive, via a control plane established between the RU 170-c and the DU 165-c over a fronthaul interface (e.g., the fronthaul communication link 168), a control-plane packet that indicates control information. The control information may indicate periodic resources in multiple TTIs allocated for communication of traffic between the RU 170-c and one or more UEs 115 served by the RU 170-c or both. In some examples, the control-plane packet may indicate a starting SFN associated with the periodic resources, a starting TTI associated with the periodic resources, a layer identifier associated with the periodic resources, a quantity of TTIs associated with the periodic resources, or any combination thereof. For example, the control-plane packet may include one or more fields that indicate the starting SFN, starting TTI, or the layer identifier, the quantity of TTIs. In some examples, the control-plane packet may include one or more section type commands. Each section type command may indicate a layer identifier of the periodic resource allocation (e.g., eAxc ID) and a periodicity corresponding to the identifier in a quantity of TTIs (e.g., slots).

Additionally, or alternatively, the control-plane packet may include a section extension. The section extension may indicate an extension field, an extension flag, a section extension type, an extension length, an allocation identifier, a starting flag associated with the periodic resources, a stopping flag associated with the periodic resources, a periodicity associated with the periodic resources, or any combination thereof. The extension length may indicate the length of one or more fields corresponding to the allocation identifier, start or stop flag, and the periodicity.

At 410, the RU 170-c may receive, in the control-plane packet, a starting indication associated with the periodic resources. Based on receiving the starting indication, the RU 170-c may transmit one or more messages with a UE 115, execute one or more commands, or any combination thereof in accordance with the control information.

At 415, the RU 170-c may receive an indication of a quantity of TTIs between receipt of the control-plane packet and when the control-plane packet is to be applied. Additionally, or alternatively, the RU 170-c may receive an indication of a quantity of TTIs between communicating the one or more messages in accordance with the periodicity and stopping communication of the one or more messages in accordance with the periodicity (e.g., indicating how many slots to apply the periodicity).

In one example implementation, at 420, the RU 170-c may communicate, via a first resource of the periodic resources, a first message with the DU 165-c based on the control information. For example, the RU 170-c may transmit the first message to the DU 165-c based on an expiration of a first duration corresponding to the periodicity (e.g., based on an expiration of the periodicity, the RU 170-c may communicate with the DU 165-c).

At 425, the RU 170-c may communicate, via a second resource of the periodic resources, a second message with the DU 165-c based on the control information. For example, the RU 170-c may transmit the second message to the DU 165-c based on an expiration of a second duration corresponding to the periodicity (e.g., based on an expiration of the periodicity, the RU 170-c may communicate with the DU 165-c). In some examples, the second resource and the first resource may occur in different TTIs of the multiple TTIs allocated for communication. In some examples, the RU 170-c may communicate the first message and the second message based on the starting indication. Additionally, or alternatively, the RU 170-c may communicate the first message and the second message after the quantity of TTIs has elapsed. In some examples, the RU 170-c may execute one or more commands (e.g., periodic energy-saving commands) based on the control information. In some cases, the RU 170-c may communicate the first message, the second message, or both, based on executing the one or more commands.

At 430, the RU 170-c may receive, via the control plane and over the fronthaul interface, a second control-plane packet that includes second control data that may overwrite or stop the resource allocation. That is, the first control-plane packet may include an allocation identifier and a control section field that includes first control data, and the second control-plane packet may include the same allocation identifier and a control section field that includes second control data. Based on receiving the second control information, the RU 170-c may not apply the first control data. In some cases, the first control-plane packet may indicate the RU 170-c to apply the first control data in one or more TTIs of the multiple TTIs until a subsequent control-plane packet (e.g., the second control-plane packet) is received that includes the allocation identifier.

At 435, the RU 170-c may receive a stop indication associated with the periodic resources. Based on receiving the stop indication, the RU 170-c may cease communication with a UE 115 or with the DU 165-c in accordance with the periodic resource allocation. In some examples, the RU 170-c may receive the stop indication within the control-plane packet. In some other examples, the RU 170-c may receive the stop indication within the second control-plane packet.

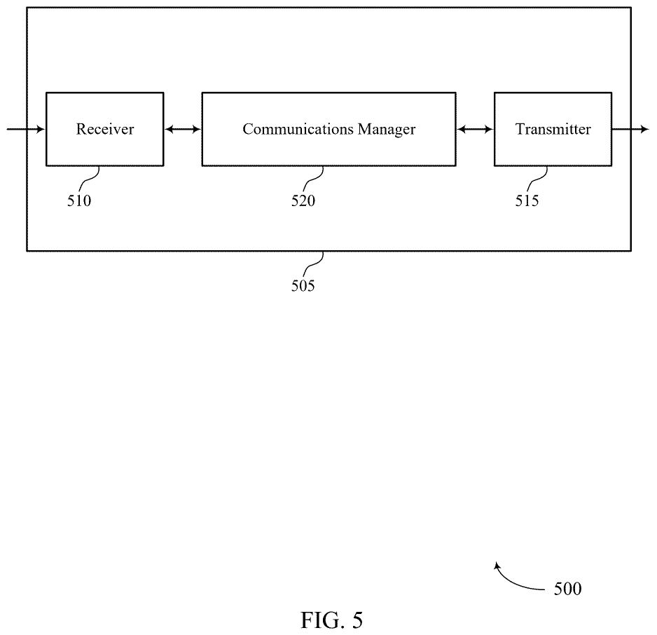

FIG. 5 shows a block diagram 500 of a device 505 that supports fronthaul load enhancement for periodic information in RANs in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of fronthaul load enhancement for periodic information in RANs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a control plane established between the radio unit node and a distributed unit node over a fronthaul interface, a control-plane packet that indicates control information, the control information indicating periodic resources in a set of multiple TTIs allocated for communication of traffic associated with the radio unit node. The communications manager 520 is capable of, configured to, or operable to support a means for communicating, via a first resource of the periodic resources, a first message based on the control information. The communications manager 520 is capable of, configured to, or operable to support a means for communicating, via a second resource of the periodic resources, a second message based on the control information, the second resource and the first resource occurring in different TTIs of the set of multiple TTIs.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources, among other examples.

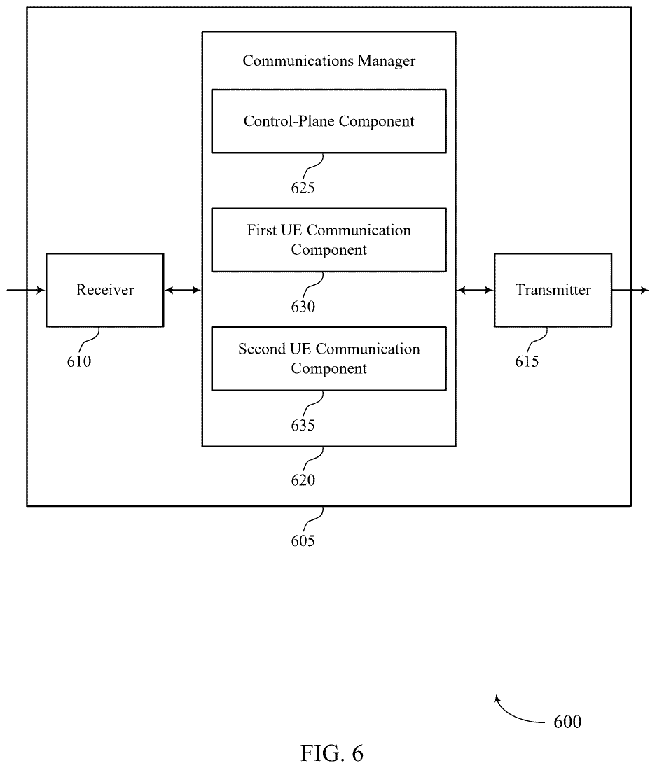

FIG. 6 shows a block diagram 600 of a device 605 that supports fronthaul load enhancement for periodic information in RANs in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of fronthaul load enhancement for periodic information in RANs as described herein. For example, the communications manager 620 may include a control-plane component 625, a first UE communication component 630, a second UE communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control-plane component 625 is capable of, configured to, or operable to support a means for receiving, via a control plane established between the radio unit node and a distributed unit node over a fronthaul interface, a control-plane packet that indicates control information, the control information indicating periodic resources in a set of multiple TTIs allocated for communication of traffic associated with the radio unit node. The first UE communication component 630 is capable of, configured to, or operable to support a means for communicating, via a first resource of the periodic resources, a first message based on the control information. The second UE communication component 635 is capable of, configured to, or operable to support a means for communicating, via a second resource of the periodic resources, a second message based on the control information, the second resource and the first resource occurring in different TTIs of the set of multiple TTIs.

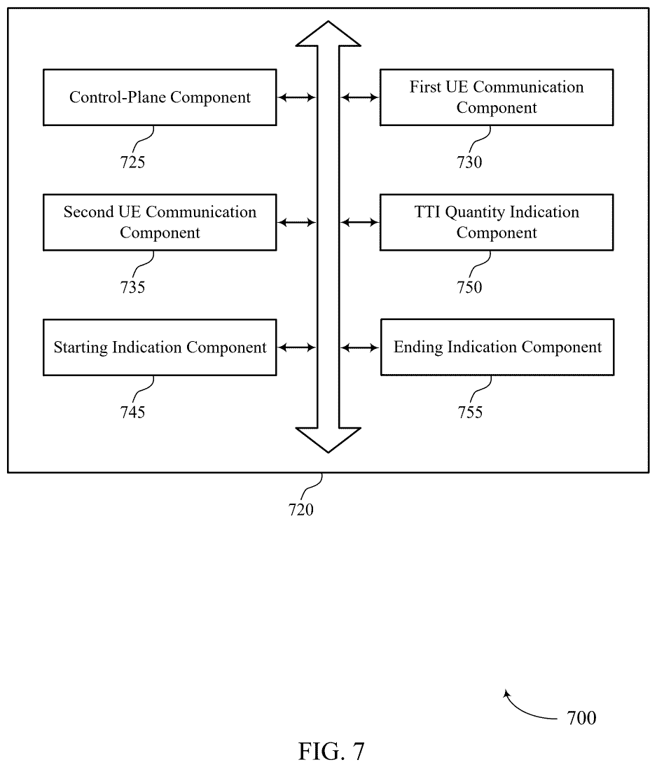

FIG. 7 shows a block diagram 700 of a communications manager 720 that supports fronthaul load enhancement for periodic information in RANs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of fronthaul load enhancement for periodic information in RANs as described herein. For example, the communications manager 720 may include a control-plane component 725, a first UE communication component 730, a second UE communication component 735, a starting indication component 745, a TTI quantity indication component 750, an ending indication component 755, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The control-plane component 725 is capable of, configured to, or operable to support a means for receiving, via a control plane established between the radio unit node and a distributed unit node over a fronthaul interface, a control-plane packet that indicates control information, the control information indicating periodic resources in a set of multiple TTIs allocated for communication of traffic associated with the radio unit node. The first UE communication component 730 is capable of, configured to, or operable to support a means for communicating, via a first resource of the periodic resources, a first message based on the control information. The second UE communication component 735 is capable of, configured to, or operable to support a means for communicating, via a second resource of the periodic resources, a second message based on the control information, the second resource and the first resource occurring in different TTIs of the set of multiple TTIs.

In some examples, the starting indication component 745 is capable of, configured to, or operable to support a means for receiving, in the control-plane packet, a starting indication associated with the periodic resources, where the first message and the second message are communicated based on the starting indication. In some examples, the ending indication component 755 is capable of, configured to, or operable to support a means for receiving, in the control-plane packet, a stop indication associated with the periodic resources.

In some examples, the TTI quantity indication component 750 is capable of, configured to, or operable to support a means for receiving an indication of a quantity of TTIs between receipt of the control-plane packet and when the control-plane packet is to be applied, where the first message and the second message are communicated after the quantity of TTIs has elapsed. In some examples, the control-plane packet includes an allocation identifier and a control section field that includes first control data, the control-plane packet indicating to apply the first control data in one or more TTIs of the set of multiple TTIs until a subsequent control-plane packet is received that includes the allocation identifier.

In some examples, a starting SFN associated with the periodic resources; a starting TTI associated with the periodic resources; a layer identifier associated with the periodic resources; a quantity of TTIs associated with the periodic resources, or any combination thereof. In some examples, the control-plane packet may include an extension flag, a section extension type, an extension length, an allocation identifier, a starting flag associated with the periodic resources, a stopping flag associated with the periodic resources, a periodicity associated with the periodic resources, or any combination thereof.

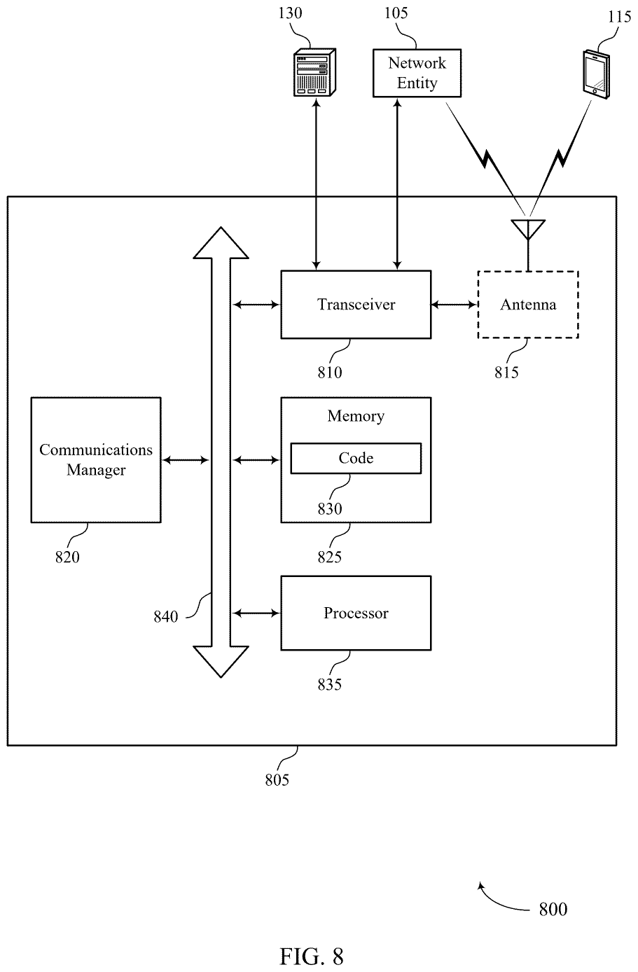

FIG. 8 shows a diagram of a system 800 including a device 805 that supports fronthaul load enhancement for periodic information in RANs in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting fronthaul load enhancement for periodic information in RANs). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for receiving, via a control plane established between the radio unit node and a distributed unit node over a fronthaul interface, a control-plane packet that indicates control information, the control information indicating periodic resources in a set of multiple TTIs allocated for communication of traffic associated with the radio unit node. The communications manager 820 is capable of, configured to, or operable to support a means for communicating, via a first resource of the periodic resources, a first message based on the control information. The communications manager 820 is capable of, configured to, or operable to support a means for communicating, via a second resource of the periodic resources, a second message based on the control information, the second resource and the first resource occurring in different TTIs of the set of multiple TTIs.

By including or configuring the communications manager 820 in accordance with examples as described herein, the device 805 may support techniques for reduced latency, reduced power consumption, more efficient utilization of communication resources, and improved utilization of processing capability, among other examples.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of fronthaul load enhancement for periodic information in RANs as described herein, or the at least one processor 835 and the at least one memory 825 may be otherwise configured to, individually or collectively, perform or support such operations.

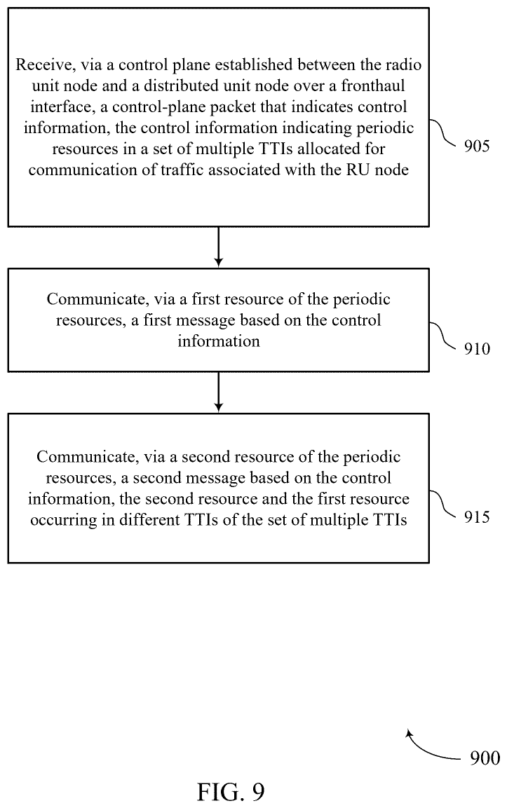

FIG. 9 shows a flowchart illustrating a method 900 that supports fronthaul load enhancement for periodic information in RANs in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include receiving, via a control plane established between the radio unit node and a distributed unit node over a fronthaul interface, a control-plane packet that indicates control information, the control information indicating periodic resources in a set of multiple TTIs allocated for communication of traffic associated with the radio unit node. The operations of 905 may be performed in accordance with examples as disclosed herein. In some examples, aspects of the operations of 905 may be performed by a control-plane component 725 as described with reference to FIG. 7.

At 910, the method may include communicating, via a first resource of the periodic resources, a first message based on the control information. The operations of 910 may be performed in accordance with examples as disclosed herein. In some examples, aspects of the operations of 910 may be performed by a first UE communication component 730 as described with reference to FIG. 7.

At 915, the method may include communicating, via a second resource of the periodic resources, a second message based on the control information, the second resource and the first resource occurring in different TTIs of the set of multiple TTIs. The operations of 915 may be performed in accordance with examples as disclosed herein. In some examples, aspects of the operations of 915 may be performed by a second UE communication component 735 as described with reference to FIG. 7.

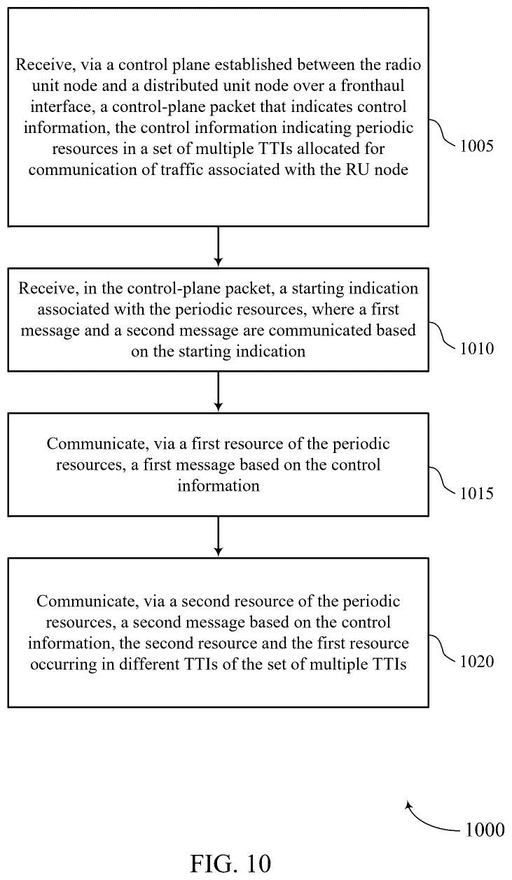

FIG. 10 shows a flowchart illustrating a method 1000 that supports fronthaul load enhancement for periodic information in RANs in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include receiving, via a control plane established between the radio unit node and a distributed unit node over a fronthaul interface, a control-plane packet that indicates control information, the control information indicating periodic resources in a set of multiple TTIs allocated for communication of traffic associated with the radio unit node. The operations of 1005 may be performed in accordance with examples as disclosed herein. In some examples, aspects of the operations of 1005 may be performed by a control-plane component 725 as described with reference to FIG. 7.

At 1010, the method may include receiving, in the control-plane packet, a starting indication associated with the periodic resources, where a first message and a second message are communicated based on the starting indication. The operations of 1010 may be performed in accordance with examples as disclosed herein. In some examples, aspects of the operations of 1010 may be performed by a starting indication component 745 as described with reference to FIG. 7.

At 1015, the method may include communicating, via a first resource of the periodic resources, the first message with a first UE of the one or more UEs based on the resource allocation and the periodicity. The operations of 1015 may be performed in accordance with examples as disclosed herein. In some examples, aspects of the operations of 1015 may be performed by a first UE communication component 730 as described with reference to FIG. 7.

At 1020, the method may include communicating, via a second resource of the periodic resources, the second message with the first UE or a second UE of the one or more UEs based on the resource allocation and the periodicity, the second resource and the first resource occurring in different TTIs of the set of multiple TTIs. The operations of 1020 may be performed in accordance with examples as disclosed herein. In some examples, aspects of the operations of 1020 may be performed by a second UE communication component 735 as described with reference to FIG. 7.

The following provides an overview of aspects of the present disclosure:

Aspect 1: A method for wireless communications by an RU node, comprising: receiving, via a control plane established between the RU node and a distributed unit node over a fronthaul interface, a control-plane packet that indicates control information, the control information indicating periodic resources in a plurality of TTIs allocated for communication of traffic associated with the RU node; communicating, via a first resource of the periodic resources, a first message based at least in part on the control information; and communicating, via a second resource of the periodic resources, a second message based at least in part on the control information, the second resource and the first resource occurring in different TTIs of the plurality of TTIs.

Aspect 2: The method of aspect 1, further comprising: receiving, in the control-plane packet, a starting indication associated with the periodic resources, wherein the first message and the second message are communicated based at least in part on the starting indication.

Aspect 3: The method of aspect 2, further comprising: receiving, in the control-plane packet, a stop indication associated with the periodic resources.

Aspect 4: The method of any of aspects 1 through 3, further comprising: receiving an indication of a quantity of TTIs between receipt of the control-plane packet and when the control-plane packet is to be applied, wherein the first message and the second message are communicated after the quantity of TTIs has elapsed.

Aspect 5: The method of any of aspects 1 through 4, wherein the control-plane packet comprises an allocation identifier and a control section field that includes first control data, the control-plane packet indicating to apply the first control data in one or more TTIs of the plurality of TTIs until a subsequent control-plane packet is received that comprises the allocation identifier.

Aspect 6: The method of any of aspects 1 through 5, wherein the control-plane packet indicates: a starting SFN associated with the periodic resources, a starting TTI associated with the periodic resources, a layer identifier associated with the periodic resources, a quantity of TTIs associated with the periodic resources, or any combination thereof.

Aspect 7: The method of any of aspects 1 through 5, wherein the control-plane packet comprises: an extension field, an extension flag, a section extension type, an extension length, an allocation identifier, a starting flag associated with the periodic resources, a stopping flag associated with the periodic resources, a periodicity associated with the periodic resources, or any combination thereof.

Aspect 8: An RU node for wireless communications, comprising one or more memories storing processor-executable code, and one or more processors coupled with the one or more memories and individually or collectively operable to execute the code to cause the RU node to perform a method of any of aspects 1 through 7.

Aspect 9: An RU node for wireless communications, comprising at least one means for performing a method of any of aspects 1 through 7.

Aspect 10: A non-transitory computer-readable medium storing code for wireless communications, the code comprising instructions executable by one or more processors to perform a method of any of aspects 1 through 7.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio unit node, comprising:
one or more memories storing processor-executable code; and
one or more processors coupled with the one or more memories and individually or collectively operable to execute the code to cause the radio unit node to:
receive, via a control plane established between the radio unit node and a distributed unit node over a fronthaul interface, a control-plane packet that indicates control information, the control information indicating periodic resources in a plurality of transmission time intervals (TTIs) allocated for communication of traffic associated with the radio unit node;
communicate, via a first resource of the periodic resources, a first message based at least in part on the control information; and
communicate, via a second resource of the periodic resources, a second message based at least in part on the control information, the second resource and the first resource occurring in different TTIs of the plurality of TTIs.

2. The radio unit node of claim 1, wherein the one or more processors are individually or collectively further operable to execute the code to cause the radio unit node to:
receive, in the control-plane packet, a starting indication associated with the periodic resources, wherein the first message and the second message are communicated based at least in part on the starting indication.

3. The radio unit node of claim 2, wherein the one or more processors are individually or collectively further operable to execute the code to cause the radio unit node to:
receive, in the control-plane packet, a stop indication associated with the periodic resources.

4. The radio unit node of claim 1, wherein the one or more processors are individually or collectively further operable to execute the code to cause the radio unit node to:
receive an indication of a quantity of TTIs between receipt of the control-plane packet and when the control-plane packet is to be applied, wherein the first message and the second message are communicated after the quantity of TTIs has elapsed.

5. The radio unit node of claim 1, wherein the control-plane packet comprises an allocation identifier and a control section field that includes first control data, the control-plane packet indicating to apply the first control data in one or more TTIs of the plurality of TTIs until a subsequent control-plane packet is received that comprises the allocation identifier.

6. The radio unit node of claim 1, wherein the control-plane packet indicates:
a starting system frame number associated with the periodic resources;
a starting TTI associated with the periodic resources;
a layer identifier associated with the periodic resources;
a quantity of TTIs associated with the periodic resources, or
any combination thereof.

7. The radio unit node of claim 1, wherein the control-plane packet comprises:
an extension field, an extension flag, a section extension type, an extension length, an allocation identifier, a start flag associated with the periodic resources, a stopping flag associated with the periodic resources, a periodicity associated with the periodic resources, or any combination thereof.

8. A method for wireless communications by a radio unit node, comprising:
receiving, via a control plane established between the radio unit node and a distributed unit node over a fronthaul interface, a control-plane packet that indicates control information, the control information indicating periodic resources in a plurality of transmission time intervals (TTIs) allocated for communication of traffic associated with the radio unit node;
communicating, via a first resource of the periodic resources, a first message based at least in part on the control information; and
communicating, via a second resource of the periodic resources, a second message based at least in part on the control information, the second resource and the first resource occurring in different TTIs of the plurality of TTIs.

9. The method of claim 8, further comprising:
receiving, in the control-plane packet, a starting indication associated with the periodic resources, wherein the first message and the second message are communicated based at least in part on the starting indication.

10. The method of claim 9, further comprising:
receiving, in the control-plane packet, a stop indication associated with the periodic resources.

11. The method of claim 8, further comprising:
receiving an indication of a quantity of TTIs between receipt of the control-plane packet and when the control-plane packet is to be applied, wherein the first message and the second message are communicated after the quantity of TTIs has elapsed.

12. The method of claim 8, wherein the control-plane packet comprises an allocation identifier and a control section field that includes first control data, the control-plane packet indicating to apply the first control data in one or more TTIs of the plurality of TTIs until a subsequent control-plane packet is received that comprises the allocation identifier.

13. The method of claim 8, wherein the control-plane packet indicates:
a starting system frame number associated with the periodic resources;
a starting TTI associated with the periodic resources;
a layer identifier associated with the periodic resources;
a quantity of TTIs associated with the periodic resources, or
any combination thereof.

14. The method of claim 8, wherein the control-plane packet comprises:
an extension field, an extension flag, a section extension type, an extension length, an allocation identifier, a starting flag associated with the periodic resources, a stopping flag associated with the periodic resources, a periodicity associated with the periodic resources, or any combination thereof.

15. A non-transitory computer-readable medium storing code for communications, the code comprising instructions executable by one or more processors to:
receive, via a control plane established between a radio unit node and a distributed unit node over a fronthaul interface, a control-plane packet that indicates control information, the control information indicating periodic resources in a plurality of transmission time intervals (TTIs) allocated for communication of traffic associated with the radio unit node;
communicate, via a first resource of the periodic resources, a first message based at least in part on the control information; and
communicate, via a second resource of the periodic resources, a second message based at least in part on the control information, the second resource and the first resource occurring in different TTIs of the plurality of TTIs.

16. The non-transitory computer-readable medium of claim 15, wherein the instructions are further executable by the one or more processors to:
receive, in the control-plane packet, a starting indication associated with the periodic resources, wherein the first message and the second message are communicated based at least in part on the starting indication.

17. The non-transitory computer-readable medium of claim 16, wherein the instructions are further executable by the one or more processors to:
receive, in the control-plane packet, a stop indication associated with the periodic resources.

18. The non-transitory computer-readable medium of claim 15, wherein the instructions are further executable by the one or more processors to:
receive an indication of a quantity of TTIs between receipt of the control-plane packet and when the control-plane packet is to be applied, wherein the first message and the second message are communicated after the quantity of TTIs has elapsed.

19. The non-transitory computer-readable medium of claim 15, wherein the control-plane packet indicates:
a starting system frame number associated with the periodic resources;
a starting TTI associated with the periodic resources;
a layer identifier associated with the periodic resources;
a quantity of TTIs associated with the periodic resources, or
any combination thereof.

20. The non-transitory computer-readable medium of claim 15, wherein the control-plane packet comprises:
an extension field, an extension flag, a section extension type, an extension length, an allocation identifier, a start flag associated with the periodic resources, a stopping flag associated with the periodic resources, a periodicity associated with the periodic resources, or any combination thereof.
